(19) United States
(12) Patent Application Publication
(10) Pub. No.: US 2013/0228624 A1
(43) Pub. Date: Sep. 5, 2013

(54) METHOD AND APPARATUS FOR TRANSFERRING AND RECEIVING DATA USING MULTI-FRAME BAR CODES

(71) Applicants: Nathaniel Byrd, Saint Peters, MO (US); David Brown, Dardenne Prairie, MO (US)

(72) Inventors: Nathaniel Byrd, Saint Peters, MO (US); David Brown, Dardenne Prairie, MO (US)

(73) Assignee: MASTERCARD INTERNATIONAL INCORPORATED, Purchase, NY (US)

(21) Appl. No.: 13/410,335

(22) Filed: Mar. 2, 2012

(51) Int. Cl. G06K 7/10; G06K 19/06

(52) U.S. Cl. 235/462.11; 235/494; 235/462.41

(57) ABSTRACT

Methods of transferring or receiving data using a multi-frame bar code are disclosed. A sequence of bar codes includes a plurality of bar codes displayed in a sequence, with each bar code in the plurality of bar codes being encoded with data and the sequence of bar codes conveying a coherent set of data. The sequence of bar codes is displayed, in a display device, such that only one bar code in the plurality of bar codes is displayed at any one time to constitute a three-dimensional (two spatial, one temporal) bar code when using a bar code. The bar codes are read, in a reader device, and then analyzed to identify each bar code in the sequence of bar codes. Each bar code is decoded to obtain the decoded data, which may then be combined into a coherent set of data.

### FIELD

The present disclosure relates to the transfer and receipt of data, specifically through the use of a multi-frame bar code.

### BACKGROUND

Bar codes have become a regular part of life for consumers and businesses alike. Bar codes are seen by consumers on a daily basis being affixed to products and advertisements, and commonly used in the purchase of goods. Two dimensional bar codes have entered widespread use recently, having the advantages of faster reading times and greater information and content than many traditional one dimensional bar codes and being able to convey a significantly larger amount of data.

However, for many applications, traditional one or two dimensional bar codes are ineffective. For example, their physical size may make them difficult to use in certain applications. In other instances, traditional one or two dimensional bar codes may not hold enough data to be suitable for some applications. Simultaneous display of multiple bar codes is not visually appealing and require a person to scan multiple times, perhaps in a prescribed sequence. Thus, there exists a need for a bar code that can hold more data than the traditional, single-frame one or two dimensional bar code.

### SUMMARY

The present disclosure provides a description of methods, devices, and codes for the transfer or receipt of data using multi-frame bar codes.

An exemplary method of transferring data includes compiling a sequence of bar codes, the sequence including a plurality of bar codes each encoded with data. The method further includes displaying, in a display device, the compiled sequence of bar codes in a sequence such that only one of the plurality of bar codes is displayed at any one time.

An exemplary method of receiving data includes reading, in a reader device, a compiled sequence of bar codes. The sequence of bar codes includes a plurality of bar codes each encoded with data and is displayed in a sequence such that only one of the sequence of a plurality of bar codes is displayed at any one time. The method further includes analyzing the compiled sequence of bar codes to identify each bar code of the plurality of bar codes, and decoding each bar code in the plurality of bar codes to obtain the encoded data.

An exemplary time-varying code includes a sequence of bar codes, the sequence of bar codes including a plurality of bar codes each encoded with data. The sequence of bar codes is to be displayed, in a display device, in a sequence such that at least two of the bar codes of the plurality of bar codes are displayed in succession. The sequence of bar codes also conveys a coherent set of data.

An exemplary sequence of bar codes includes a plurality of bar codes encoded with data. The sequence of bar codes is to be displayed, in a display device, in a sequence such that only one of the plurality of bar codes is displayed at any one time.

An exemplary device includes a reader configured to read a dynamically displayed sequence of bar codes. The sequence of bar codes includes a plurality of bar codes each encoded with data. At least two of the bar codes of the plurality of bar codes are shown in succession, and the sequence of bar codes conveys a coherent set of data. The device further includes a processor configured to analyze the sequence of bar codes to identify each bar code in the plurality of bar codes, to decode each identified bar code to obtain the encoded data, and to compile the encoded data to obtain the coherent set of data.

Another exemplary method for transferring data includes receiving a coherent set of data, dividing the coherent set of data into a plurality of data subsets and encoding each data subset of the plurality of data subset into a bar code of a plurality of bar codes. The method further includes compiling the plurality of bar codes into a sequence of bar codes, and encoding each bar code of the plurality of bar codes with a frame identifier, the frame identifier indicating a position of the bar code in the sequence of bar codes. The compiled sequence of bar codes is displayed, in a display device, in a sequence such that one of the compiled sequence of a plurality of bar codes is displayed at a time, in one embodiment.

### BRIEF DESCRIPTION OF THE DRAWING FIGURES

Exemplary embodiments are best understood from the following detailed description when read in conjunction with the accompanying drawings. It is emphasized that, according to common practice, the various features of the drawings are not to scale. On the contrary, the dimensions of the various features may be arbitrarily expanded or reduced for clarity. Included in the drawings are the following figures:

FIG. 1 is a block diagram illustrating a system for the transfer of data using a multi-frame bar code in accordance with exemplary embodiments.

FIGS. 2A-2F are block diagrams illustrating a system of transferring data using a multi-frame bar code in accordance with exemplary embodiments.

FIG. 3 is a block diagram illustrating a reader device for reading a multi-frame bar code in accordance with exemplary embodiments.

FIG. 4 is a block diagram illustrating a display device for displaying a multi-frame bar code in accordance with exemplary embodiments.

FIG. 5 is a flow chart illustrating a method for transferring data in accordance with exemplary embodiments.

FIG. 6 is a flow chart illustrating a method for receiving data in accordance with exemplary embodiments.

FIGS. 7-9 are flow charts illustrating exemplary methods for receiving data encoded in a repeating multi-frame bar code in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

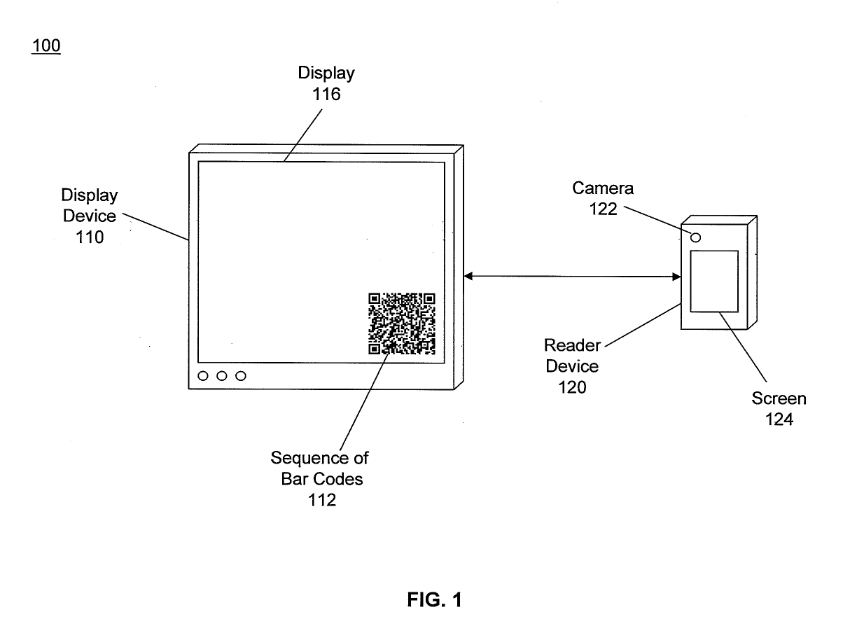

FIG. 1 is a block diagram illustrating a system 100 for the transfer of data using a multi-frame bar code.

The system 100 may include a display device 110 and a reader device 120. The display device 110 may include a display 116 configured to display a multi frame bar code (sequence of bar codes) 112, described in more detail below. The display device 110 may be any device capable of displaying the sequence of bar codes 112, such as a television, a computer monitor, a liquid crystal display (LCD), a light-emitting diode (LED) display, a flexible organic light-emitting diode (OLED) display, electric ink display, etc. Other types of displays suitable for displaying a multi-frame bar code will be apparent to persons having skill in the relevant art(s).

The reader device 120 may include a camera 122 or nearly any other imaging device capable of reading bar codes, including those with elements visible and/or not visible to humans, and a screen 124. In one embodiment the reader device 120 is a mobile communication device, such as a smart phone dedicated scanners. The imaging device 122 may be any tablet computer, PDA's, or nearly any suitable device capable of reading bar codes imager configured to read a sequence of bar codes 112. The imaging device 122 may be configured to record video, to capture still images, a sequence of still images, or capture both still images and video or a combination thereof.

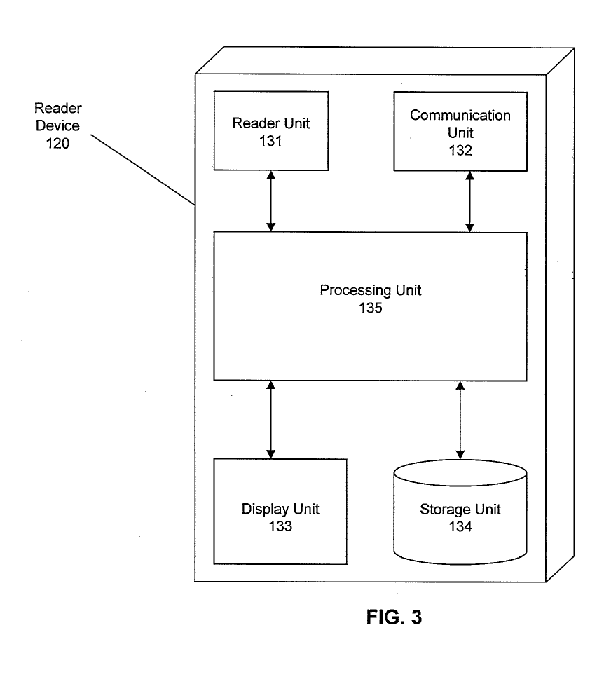

The reader device 120 may also include a processor (e.g., processing unit 135 illustrated in FIG. 3) configured to decode data encoded in the sequence of bar codes 112 (described in further detail below) and combine the decoded data into a coherent set of data. Here it is noted that the imaging device and the process can be physically or virtually separated so long as a communications path exists there between. The screen 124 may be any type of display configured to display data (e.g., the coherent set of data) to a user of the reader device 120, for example, an LCD, an LED display, a flexible OLED display, electric ink, etc. The screen 124 may also be a display configured to accept input from a user of the reader device 120 as well as display data, such as a touch display for example. Nearly any suitable input device is contemplated.

### Multi-Frame Bar Code

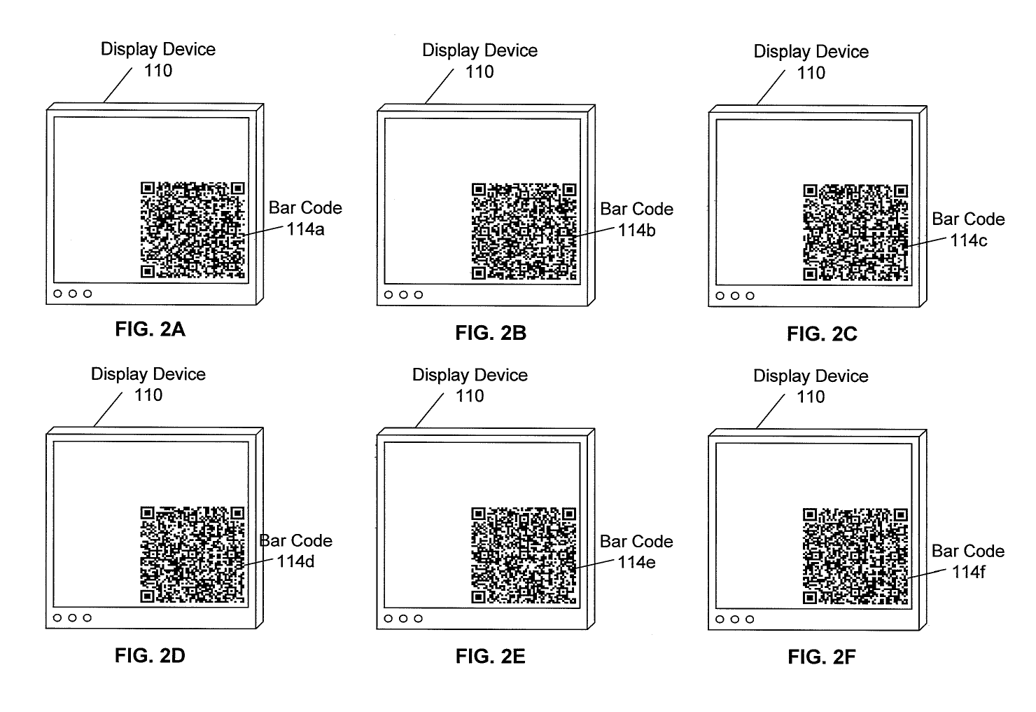

FIGS. 2A-2F are block diagrams illustrating a system of transferring data using a multi-frame bar code (sequence of bar codes 112).

The sequence of bar codes 112 may include a plurality of bar codes (e.g., bar codes 114a-114f). The bar codes 114a-114f may be one dimensional on linear bar codes (e.g., a universal product code), two dimensional bar codes (e.g., a Data Matrix code, QR code, etc.), or a combination of both one and two dimensional bar codes. If geometric 3D bar codes become common, the present system could be used in an exemplary embodiment, the bar codes 114a-114f are QR codes. The sequence of bar codes 112 may be time-varying, may be displayed at a video frame rate, or may be displayed as a series of still images either faster or slower than normal video frame rates. The sequence of bar codes can look to the human eye to be morphing, or beyond human perception. The sequence of bar codes can be embedded images (e.g., trademarks) that do not form part of or interfere with the reading of the bar code.

The bar codes 114a-114f may be encoded with data. Each bar code 114a-114f may be encoded with data unique to the individual bar code. In one embodiment, the data from each bar code 114a-114f may be decoded and combined into a coherent set of data. For example, the bar codes 114a-114f each may be encoded with unique text that, when combined, forms a coherent paragraph. In one embodiment, each of the bar codes 114a-114f includes the same amount of data (e.g., an identical number of alphanumeric characters). In other embodiments, each of the bar codes 114a-114f may include a different amount of data.

The bar codes 114a-114f may also be encoded with a frame identifier. A frame identifier may be a unique identification (e.g., a number) of the order of the bar code in the sequence of bar codes 112. For example, the bar code 114a may be encoded with “001” as a frame identifier, whereas the bar code 114c may be encoded with “003” as a frame identifier. In some embodiments, the bar codes 114a-114f may be further encoded with a total sequence identifier, e.g., a number signifying the total number of bar codes in the sequence of bar codes 112. For example, if the sequence of bar codes 112 included six bar codes (as illustrated in FIGS. 2A-2F, for example), then each of the bar codes 114a-114f may be encoded with the total sequence identifier “006.” In some embodiments, each of the bar codes 114a-114f may be encoded with both a frame identifier and a total sequence identifier. For example, the bar code 114a may be encoded with “001:006” so that the reader device 120 could decode the data and identify bar code 114a as the first bar code in a sequence of six bar codes.

Of course, the individual bar codes can be presented in any sequence, and the information sorted or sequenced in past-acquisition processing. Alternatively or additionally, the individual bar codes can each be discrete data sets, either unrelated or related to a topic, and may not need to be processed or viewed in a particular sequence. For instance, the bar codes can include information about a single product, transaction, coupon, place, item, etc., but can be a series of bar codes, such as individual product codes for all objects in a scene (e.g., information and product codes for clothing or props used in a television program, etc.) with different codes being shown at or less than the frame rate of the video, such that a list of products can be displayed on the reader device 120.

In some embodiments, a bar code (e.g., bar code 114a or bar code 114f) may be encoded to indicate the beginning or the end of the sequence of bar codes 112. In one embodiment, a bar code encoded to indicated the beginning or end of the sequence of bar codes 112 may not be encoded with any additional data. Much more complicated mechanisms, such as contextual analysis or header information are also contemplated.

The sequence of bar codes 112 may be displayed once or multiple times in succession. In one embodiment, the display of the sequence of bar codes 112 may be repeated indefinitely. The use of frame and total sequence identifiers, or of beginning and ending indications, may provide for a more efficient reading of the sequence of bar codes 112 by the reader device 120. For example, if the sequence of bar codes 112 is displayed and repeated indefinitely, without any included identifying information, it may take additional time or resources for the reader device 120 to discern when the sequence of bar codes 112 begins or ends, or what order the bar codes 114a-114f should be in.

### The Reader Device

FIG. 3 is a block diagram illustrating the reader device 120 for reading a multi-frame bar code in accordance with exemplary embodiments.

The reader device 120 may include a reader unit 131, a communication unit 132, a display unit 133, a storage unit 134, and a processing unit 135. The reader device 120 may be any device configured to perform the functions as described herein, such as a cell phone, a tablet computer, a laptop computer, or a smart phone.

The reader unit 131 may be configured to read a multi-frame bar code, such as the sequence of bar codes 112. The reader unit 131 may control the camera 122 in order to read the sequence of bar codes 112. The reader unit 131 may be configured to capture a video recording of the sequence of bar codes 112, to record a series of still images of the sequence of bar codes 112, or a combination thereof. Once the reader unit 131 has read the sequence of bar codes 112, the read bar codes (e.g., bar codes 114a-114f) may be stored in the storage unit 134. The storage unit 134 may be a part of the reader device 120, or may be external to the reader device 120 (e.g., in the cloud) and may be accessed by the communication unit 132 through a communication network (not shown) such as a mobile communication network, WiFi, local area network (LAN), the Internet, etc.

The processing unit 135 may be configured to analyze the read and stored sequence of bar codes 112. The sequence of bar codes 112 may be analyzed by decoding each bar code (e.g., bar codes 114a-114f) in the sequence of bar codes 112 to obtain data encoded in each bar code. Suitable decoding methods will be apparent to persons having skill in the relevant art(s).

The processing unit 135 may also be configured to combine the decoded data corresponding to each bar code into a coherent set of data. In some embodiments, the decoded data may need to be reordered (e.g., if the sequence of bar codes 112 is read starting from a frame other than the first frame of the sequence), such as by using a frame and/or total sequence identifier. The coherent set of data may include any type of data suitable for transfer or receipt in accordance with the present disclosure. For example, the coherent set of data may include product information, an advertisement or offer, technical information, exhibit information at a museum or gallery, product instructions, literature, contact information transaction details, payment information, coupons, etc. The coherent set of data may also include machine instructions to instruct the reader device 120 to perform a specific function if capable (e.g., display a website, display a video, play a song, etc.). The types of data disclosed herein are provided for purposes of example only, and are by no means a limitation.

In some embodiments, the functions performed by the processing unit 135 may be performed by a processor or processors external to the reader device 120 and communicated to the reader device 120 through the communication unit 132. For example, the sequence of bar codes 112 may be read or imaged by the reader device 120 and the encoded or imaged data transmitted to an external processor, which may decode and combine the decoded data into a coherent set of data, which may then be transmitted back to the reader device 120 for example.

The display unit 133 may be configured to display the coherent set of data on the reader device 120 (e.g., through the screen 124). In some embodiments, if the coherent set of data includes machine instructions, the display unit 133 may be configured to display a result of the executed machine instructions (e.g., a specific website or retrieved document). The decoded data may be executable by the reader device 120, or cause a program to react and/or process the decoded data.

### The Display Device

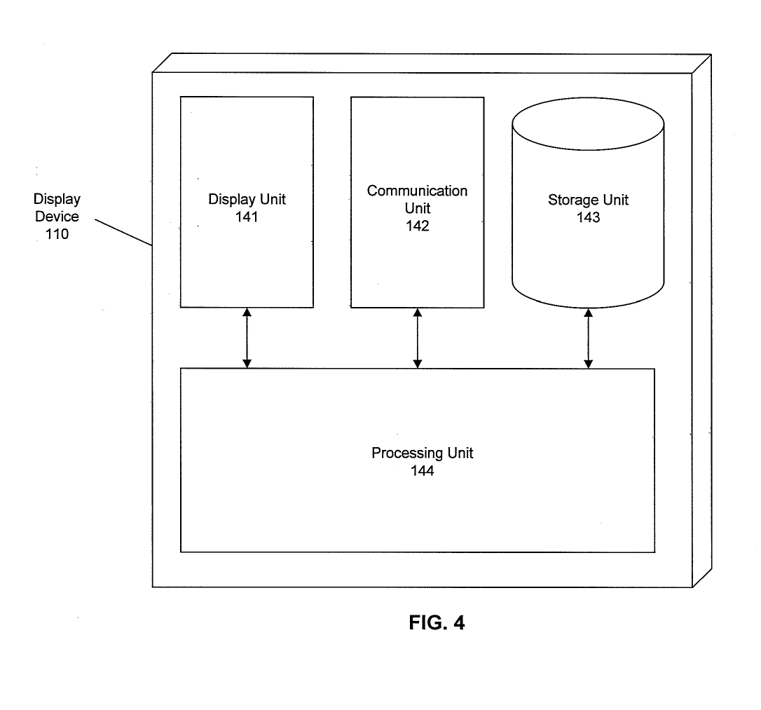

FIG. 4 is a block diagram illustrating the display device 110 for displaying a multi-frame bar code (e.g., the sequence of bar codes 112) in accordance with exemplary embodiments. It should be noted that the display device 110 or other device can be used to modify (include or delete informational content) or create a sequence of bar code frames. In this way, single or multiple contact product, event, or other information, or large data sets can be shared between reader devices 120/display devices 110. For example contact information for a group of people can be readily shared in a sequence of files over a plurality of bar codes, or a coupon or social media content (e.g., product ratings or recommendation) can be shared with other devices 120. either directly or through SMS, text, email, or other communications media, including social media sites.

The display device 110 may include a display unit 141, a communication unit 142, a storage unit 143, and a processing unit 144. The display unit 141 may be configured to control the display of the sequence of bar codes 112 on the display device 110 (e.g., through the display 116). The display unit 141 may be configured to display the sequence of bar codes 112 only once on the display 116 or display the sequence of bar codes 112 in succession one or more times (e.g., repeated indefinitely).

The sequence of bar codes 112 may be stored in the storage unit 143. In some embodiments, the storage unit 143 may be external to the display device 110 and accessed through a communication network (e.g., by the communication unit 142). In other embodiments, the storage unit 143 may be a removable storage medium, such as a removable hard disk drive, a Secure Digital (SD) card, or a digital versatile disc (DVD), etc.

The sequence of bar codes 112 may be received by the display device 110 through the communication unit 142 (e.g., through a communication network such as a local area network or the Internet). In some embodiments, the display device 110 may include an input unit (not shown) configured to receive input from a user. The sequence of bar codes 112 may then be stored in the storage unit 143. In some embodiments, the sequence of bar codes 112 may be received by the display device 110 by the insertion of a removable storage medium (e.g., a DVD, flash memory, or any other suitable tangible memory media) that may include the sequence of bar codes 112 or a coherent set of data.

In some embodiments, the display device 110 may only receive a coherent set of data. The coherent set of data may be encoded into at least one bar code (e.g., bar code 114a) by the processing unit 144. In one embodiment, the coherent set of data is divided into a plurality of data subsets and each data subset is encoded into a corresponding bar code (e.g., bar codes 114a-114f). The processing unit 144 may also encode the corresponding bar code with a frame identifier and/or a total sequence identifier as explained elsewhere herein. In one embodiment, the processing unit 144 divides the coherent set of data into at least enough data subsets necessary so that each data subset does not exceed the storage capacity of a bar code. The processing unit 144 may also be configured to combine the bar codes encoded with data into the sequence of bar codes 112. The data sub-sets can represent an arbitrary sub-set of a fatal communication. The bar codes thus can be viewed as having a header to identify its payload, and the payload. The payloads of several bar codes can then be placed together and/or used as prescribed in the header.

It will be apparent to persons having skill in the relevant art that the storage capacity of a bar code is dependent on at least both the type of bar code and the type of data. For example, alphanumeric data may require a higher storage capacity than binary data. In some embodiments, the storage capacity of a bar code may be dependent on the desired physical size of the bar code (e.g., a smaller display may require a smaller bar code, which may hold less encoded data). The coherent set of data may thus be divided in different ways to suit the individual application. For example, the data may be divided as little as possible to provide a faster displayed sequence of bar codes, or the data may be divided additional times to provide a longer displayed sequence of bar codes that takes up less physical space (e.g., for smaller or more accessible displays).

In some embodiments, the functions performed by the processing unit 144 may be performed by a processor external to the display device 110. For example, data to be encoded may be received by the display device 110 as stored on a removable storage medium (e.g., storage unit 143). The data may be transmitted to an external processor (e.g., through communication unit 142) where it may be divided, decoded into bar codes, and compiled into the sequence of bar codes 112. The display device 110 may then receive the compiled sequence of bar codes 112 (e.g., through communication unit 142) where it may then display the sequence of bar codes 112 on the display 116 (e.g., through the display unit 141).

The display device 110 may be any type of display suitable for performing the functions as disclosed herein. For example, the display device 110 may be a liquid crystal display (LCD), a light emitting diode (LED) display, a flexible organic LED (OLED) display, a television, any type of monitor, a cell phone screen (e.g., a smart phone), a tablet computer screen, electric ink display, etc. The display device 110 may display the sequence of bar codes 112 at a video frame rate, or at a faster or slower rate through a video frame rate would fir legacy device capabilities. In one embodiment, the display device 110 may display the sequence of bar codes 112 as a series of still images. The sequence of bar codes 112 may be displayed on the display 116 of the display device 110 such that only one bar code (e.g., bar code 114a) of the plurality of bar codes in a sequence (e.g., bar codes 114a-114f) may be displayed at any one time. Multiple sequence might be displayed at the same time, and a single reader device 120 may be adapted to read more than one bar code at a time.

### Method for Transferring Data Using a Multi-Frame Bar Code

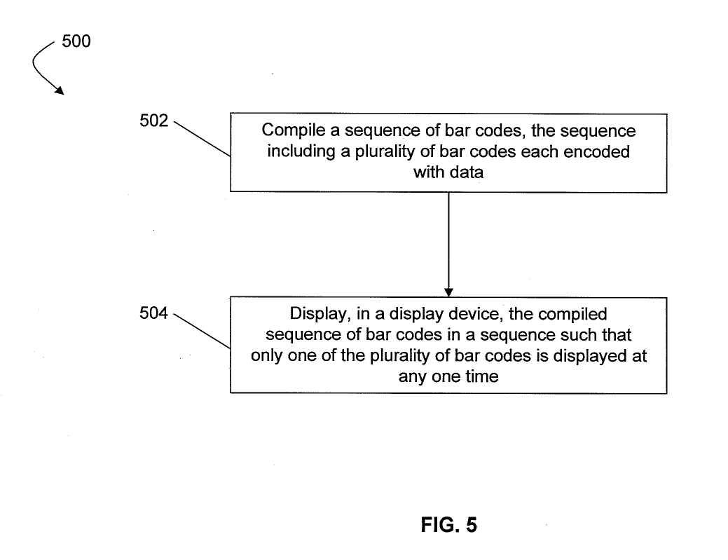

FIG. 5 illustrates a method 500 for transferring data by using a multi-frame bar code in accordance with exemplary embodiments.

In step 502, a sequence of bar codes (e.g., the sequence of bar codes 112) is compiled (e.g., by the processing unit 144). The sequence of bar codes includes a plurality of bar codes (e.g., bar codes 114a-114f) each encoded with data. In one embodiment each bar code can be further encoded with a frame identifier identifying the number of the bar code in the sequence of bar codes and/or by a unique frame identifier. In another embodiment each bar code can be further encoded with a total sequence identifier identifying the total number of bar codes in the sequence of bar codes and/or a sequence identifier. In one embodiment, each bar code is further encoded with both a frame identifier and a total sequence identifier. In some embodiments each bar code is a two dimensional bar code. In a further embodiment, the two dimensional bar code is a QR code. The present system is not limited to these examples, and any optical read code (whether visible or otherwise_ can be used. By way of non-limiting examples, these include [get list from Wikipedia for “Bar Code” at bottom]

In step 504, the compiled sequence of bar codes is displayed in a display device (e.g., the display device 110). The compiled sequence of bar codes is displayed such that only one of the plurality of bar codes (e.g., bar code 114a) is displayed at any one time. In one embodiment, the compiled sequence of bar codes is displayed at least two times in succession. In another embodiment, the display of the compiled sequence of bar codes is repeated, and might be repeated indefinitely. In one embodiment, the compiled sequence of bar codes is displayed at a video frame rate. In another embodiment, the compiled sequence of bar codes is displayed as a series of still images faster or slower than a video frame rate.

### Method for Receiving Data Using a Multi-Frame Bar Code

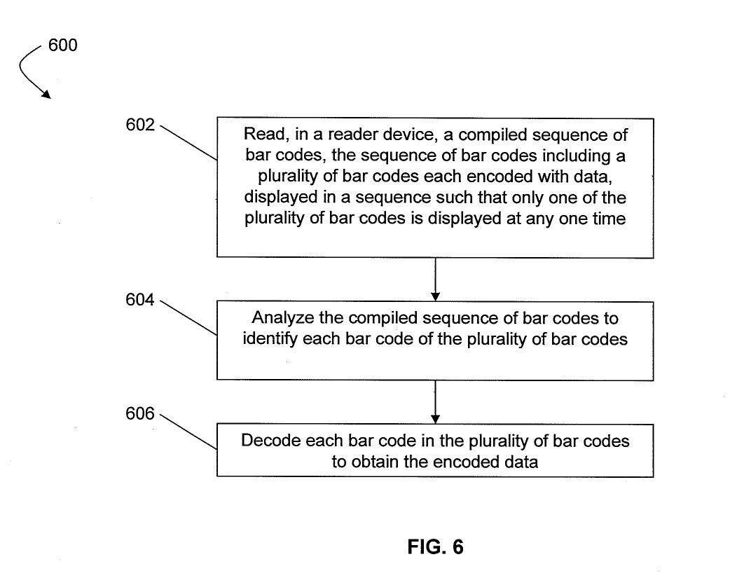

FIG. 6 illustrates a method 600 for receiving data by using a multi-frame bar code in accordance with exemplary embodiments.

In step 602, a reader device (e.g., the reader device 120) reads a compiled sequence of bar codes (e.g., the sequence of bar codes 112). The sequence of bar codes includes a plurality of bar codes (e.g., bar codes 114a-114f) each encoded with data that are displayed in a sequence such that only one of the plurality of bar codes (e.g., bar code 114a) is displayed at any one time for a given sequence (though several bar codes or sequences can be simultaneously displayed). In one embodiment, the reader device is a mobile communication device. In one embodiment each bar code is further encoded with a frame identifier identifying the number of the bar code in the sequence of bar codes as explained above. In another embodiment each bar code is further encoded with a total sequence identifier uniquely identifying the sequence and/or identifying the total number of bar codes in the sequence of bar codes. In one embodiment, each bar code is further encoded with both a frame identifier and a total sequence identifier, and optically other data.

In some embodiments each bar code is a two dimensional bar code. In a further embodiment, the two dimensional bar code is a QR code minor or standard or any suitable bar code. In one embodiment, the compiled sequence of bar codes is displayed at least two times in succession. In another embodiment, the display of the compiled sequence of bar codes is repeated and perhaps repeated indefinitely. In one embodiment, the compiled sequence of bar codes is displayed at a video frame rate or other rate, but a video frame rate or slower can mean a standard video taking function can be used. In another embodiment, the compiled sequence of bar codes is displayed as a series of still images.

In step 604, the compiled sequence of bar codes is analyzed (e.g, by the processing unit 135) to identify each bar code of the plurality of bar codes. In step 606, each bar code is decoded in order to obtain the encoded data. In one embodiment, the decoded data is combined into a set of coherent data, though discrete data can be encoded as well. In a further embodiment, the coherent data is presented (e.g., displayed) on the reader device.

### First Exemplary Method for Receiving Data Using a Multi-Frame Bar Code

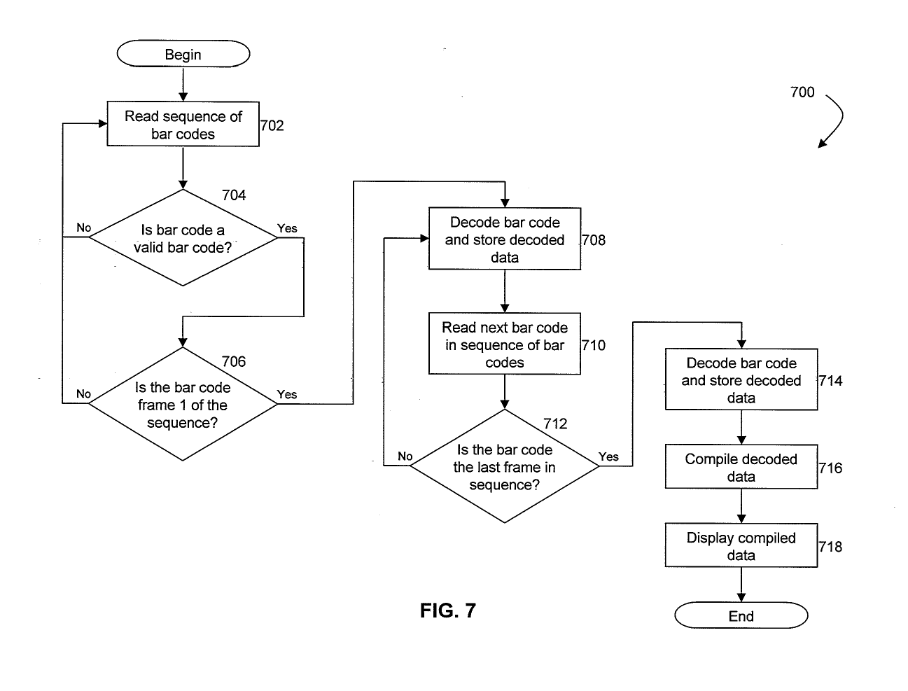

FIG. 7 is a flow chart illustrating an exemplary method for receiving data encoded in a repeating multi-frame bar code based on the location of the first frame in the sequence of frames.

In step 702, a reader device (e.g., the reader device 120) may read a sequence of bar codes that may be displayed on a display device (e.g., the sequence of bar codes 112 as displayed on the display 116 of the display device 110). In one embodiment, the sequence of bar codes may be displayed at a video frame rate but other rates are contemplated.

In step 704, the reader device may determine if the bar code is a valid bar code. If the bar code is not valid, then the device may return to step 702 and continues to read for valid bar codes. If the bar code is determined to be valid then, in step 706, the bar code may be analyzed to determine if the bar code is the first frame (e.g., the first bar code) in the sequence of bar codes. In one embodiment, the first frame in the sequence may be indicated by a frame number (e.g., “001”) encoded or otherwise stored in the bar code along with encoded data. In another embodiment, the bar code may only be encoded with an indication that it is the beginning of the sequence. If the read bar code is not the first frame, then the device may return to step 702 and continue to read bar codes until the sequence of bar codes has returned to the first frame in the sequence.

If the read bar code is the first frame in the sequence of bar codes then the bar code may be decoded in step 708 and the decoded data may be stored (e.g., in the storage unit 134). In step 710, the reader device may continue to read the sequence of bar codes, reading the next bar code in the sequence. In 712, the newly read bar code may be analyzed to determine if the bar code is the last frame in the sequence. In one embodiment, the bar code may be identified as the last frame in the sequence by an encoded frame identifier that matches an encoded total sequence identifier. In another embodiment, the bar code may be encoded with an indication that it is the last frame in the sequence. If the bar code is not the last frame, then the device may return to step 708 where the new bar code may be decoded and stored along with previously decoded and stored bar codes.

If it is determined that the bar code is the last frame in the sequence, then in step 714, the last frame may be decoded and stored and then the all of the decoded data may be compiled into a set of coherent data in step 716. The compiled set of coherent data may be displayed, in step 718, on the reader device.

### Second Exemplary Method for Receiving Data Using a Multi-Frame Bar Code

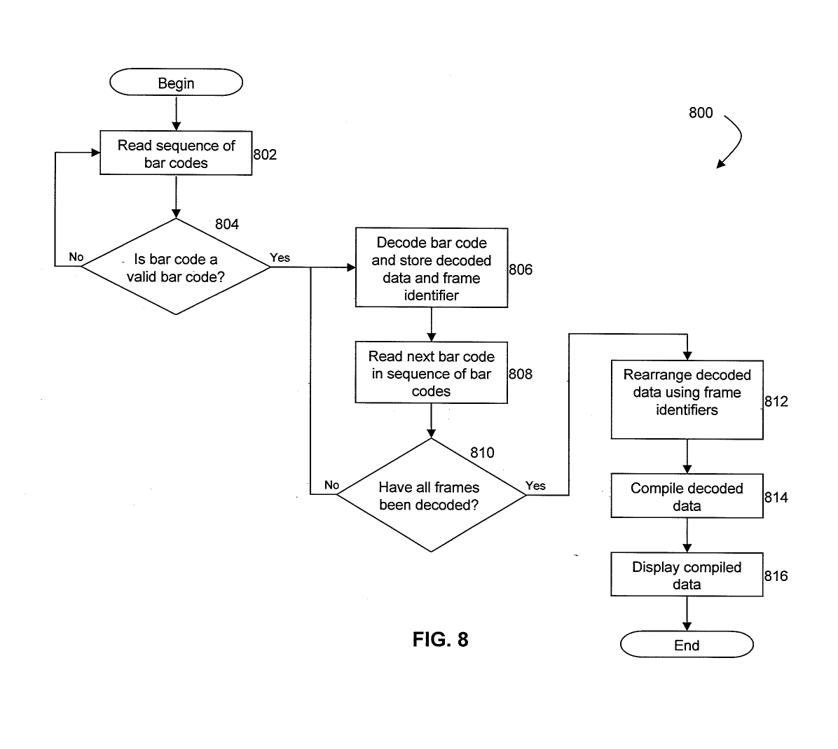

FIG. 8 is a flow chart illustrating an exemplary method for receiving data encoded in a repeating multi-frame bar code regardless of the order of the sequence of frames.

In step 802, a reader device (e.g., the reader device 120) may read a sequence of bar codes that may be displayed on a display device (e.g., the sequence of bar codes 112 as displayed on the display 116 of the display device 110). In one embodiment, the sequence of bar codes may be displayed at a video frame rate, but other rates are contemplated.

In step 804, the reader device may determine if the bar code is a valid bar code. If the bar code is not valid, then the reader device may return to step 802 and continue to read for valid bar codes. If the bar code is valid, then, in step 806, the bar code may be decoded (e.g., by the processing unit 135) and the decoded data and a frame identifier corresponding to the bar code's frame in the sequence may be stored (e.g., in the storage unit 134). In one embodiment, a total sequence identifier may also be decoded or read from the bar code and stored. In step 808, the reader device may read the next bar code in the sequence of bar codes.

In step 810, the reader device may determine if all of the bar codes have been decoded. The reader device may analyze the next bar code and compare it to previously stored bar codes. The comparison may be made, for example, by comparing bar code data, data decoded from read bar codes, frame identifiers, etc. If not all of the bar codes have been decoded (e.g., it is the first time the specific bar code in the sequence of bar codes has been read) then the process may return to step 806 and continue to read and/or decode bar codes.

If all of the bar codes have been decoded (e.g., and the sequence is repeating with no bar codes remaining to be read), then the reader device may, in step 812, rearrange all of the decoded data based on the corresponding frame identifiers. Once the decoded data has been rearranged then in step 814 it may be compiled into a set of coherent data. The set of coherent data that may be displayed on the reader device in step 816.

### Third Exemplary Method for Receiving Data Using a Multi-Frame Bar Code

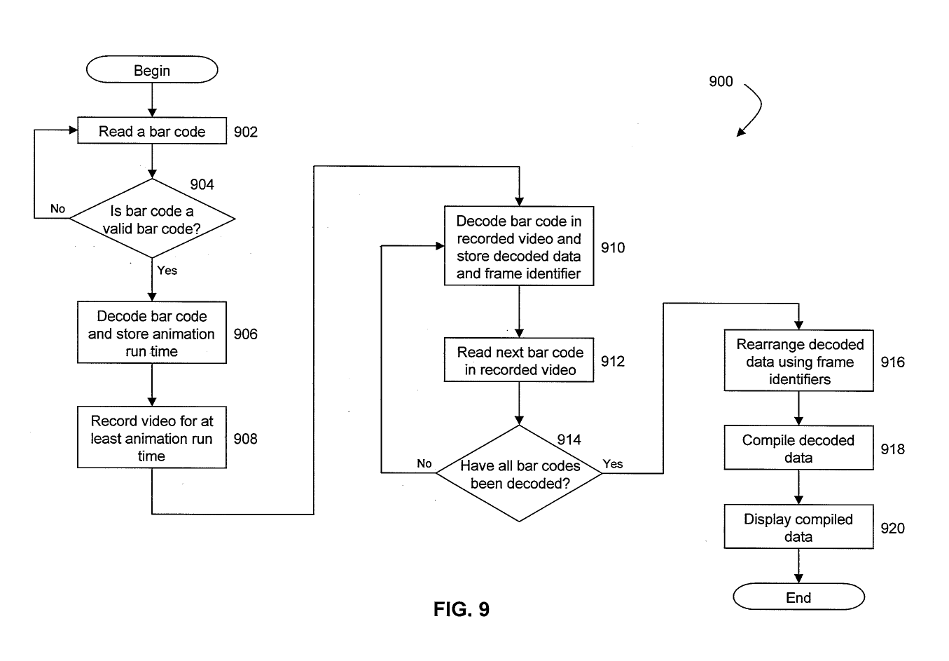

FIG. 9 is a flow chart illustrating an exemplary method for receiving data encoded in a repeating multi-frame bar code by recording a video of the entire bar code prior to decoding the bar code sequence.

In step 902, a reader device (e.g., the reader device 120) may read a bar code that may be displayed on a display device (e.g., a single bar code in the sequence of bar codes 112 as displayed on the display 116 of the display device 110). In step 904, the reader device may determine if the bar code is a valid bar code. If the bar code is not valid, then the reader device may return to step 902 and continue to read for valid bar codes. If the bar code is valid, then, in step 906, the bar code may be decoded (e.g., by the processing unit 135) and a decoded animation run time, corresponding to the length of time it takes for the entire sequence of bar codes to be displayed, may be stored (e.g., in the storage unit 134).

In step 908, the reader device may record a video for at least the animation run time. In one embodiment, the reader device may record for longer than the animation run time, such as for error correction. In one embodiment, the video may be stored on the reader device (e.g., in the storage unit 134). In another embodiment, the video may be stored external to the reader device, such as in an external database accessed via a communication network (e.g., by the communications unit 132). In step 910, the reader device may decode (e.g., by the processing unit 135) a bar code in the recorded video and the decoded data and a frame identifier corresponding to the bar code's frame in the sequence may be stored (e.g., in the storage unit 134). In one embodiment, a total sequence identifier may also be decoded or read from the bar code and stored. In step 912, the reader device may read the next bar code in the recorded video.

In step 914, the reader device may determine if all bar codes have been decoded. The reader device may analyze the next bar code and compare it to previously stored bar codes. The comparison may be made, for example, by comparing bar code data, data decoded from read bar codes, frame identifiers, etc. If the bar code has not yet been decoded or if there are still bar codes left to be decoded (e.g., it is the first time the specific bar code in the recorded video has been read or the number of frames does not match a total sequence identifier) then the process may return to step 910.

If all bar codes have been decoded, such as if the bar code is a repeat with intermediate bar codes being read (e.g., a sequence is repeating) or if all frame identifiers have been accounted for, then the reader device may, in step 916, rearrange all of the decoded data based on the corresponding frame identifiers. Once the decoded data has been rearranged then in step 918 it may be compiled into a set of coherent data. The set of coherent data that may be displayed on the reader device (e.g., using the display unit 133) in step 920.

In another exemplary embodiment, a reader device (e.g., the reader device 120) may record a video of a sequence of bar codes (e.g., the sequence of bar codes 112 as displayed on the display 116 of the display device 110) concurrently while decoding each bar code in the sequence of bar codes. In one embodiment, the reader device decodes bar codes while it records only for a decoded animation run time. In another embodiment, the reader device may continue to record video of the sequence of bar codes until each bar code in the sequence of bar codes has been read and decoded.

Where methods described above indicate certain events occurring in certain orders, the ordering of certain events may be modified. Moreover, while a process depicted as a flowchart, block diagram, etc. may describe the operations of the system in a sequential manner, it should be understood that many of the system's operations can occur concurrently. For example, although the method 700 (FIG. 7) is disclosed and illustrated as being configured to have the reader device decode a bar code and store the decoded data prior to reading the next bar code in the sequence of bar codes, it may be configured to read every bar code in the sequence of bar codes before each is decoded and the decoded data stored as well.

Techniques consistent with the present disclosure provide, among other features, systems and methods for the transfer or receipt of data using multi-frame bar codes. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method of transferring data, comprising:
compiling a sequence of bar codes, the sequence including a plurality of bar codes each encoded with data; and
displaying, in a display device, the compiled sequence of bar codes in a sequence such that only one of the plurality of bar codes is displayed at any one time.

2. The method of claim 1, wherein the complied sequence of bar codes is displayed at a video frame rate.

3. The method of claim 1, wherein the complied sequence of bar codes is displayed several times in succession, and wherein at least one of the bar codes of the plurality of bar codes indicates its position in the complied sequence of bar codes.

4. The method of claim 1, wherein each bar code of the plurality of bar codes is a two dimensional bar code.

5. The method of claim 4, wherein the two dimensional bar code is a QR code.

6. A method of receiving data, comprising:
reading, in a reader device, a compiled sequence of bar codes, the sequence of bar codes including a plurality of bar codes each encoded in a sequence with data, displayed in a sequence such that only one of the plurality of bar codes is displayed at any one time;
analyzing the compiled sequence of bar codes to identify each bar code of the plurality of bar codes; and
decoding each bar code in the plurality of bar codes to obtain the encoded data.

7. The method of claim 6, further comprising:
compiling the encoded data of each bar code in the plurality of bar codes to obtain a coherent set of data.

8. The method of claim 7, further comprising:
displaying the coherent set of data on the reader device.

9. The method of claim 6, wherein the compiled sequence of bar codes is displayed at a video frame rate.

10. The method of claim 6, wherein the compiled sequence of bar codes is displayed several times in succession, at least one of said bar codes indicating its position in the compiled sequence of bar codes.

11. The method of claim 6, wherein each bar code of the plurality of bar codes is a two dimensional bar code.

12. The method of claim 9, wherein the two dimensional bar code is a QR code.

13. The method of claim 6, wherein the reader device is a mobile communication device.

14. A time-varying code, comprising:
a sequence of bar codes, the sequence of bar codes including a plurality of bar codes each encoded with data,
wherein the sequence of bar codes is to be displayed, in a display device, in a sequence such that at least two of the bar codes of the plurality of bar codes are displayed in succession, and
wherein the sequence of bar codes conveys a set of data.

15. The time-varying code of claim 14, wherein the sequence of bar codes is displayed at a video frame rate.

16. The time-varying code of claim 14, wherein the sequence of bar codes is displayed several times in succession, at least one of said bar codes indicating its position in the sequence of bar codes to identify a beginning and end of the sequence of bar codes.

17. The time-varying code of claim 14, wherein each bar code of the plurality of bar codes is a matrix code.

18. The time-varying code of claim 14, wherein each bar code of the plurality of bar codes is a two dimensional bar code.

19. The time-varying code of claim 18, wherein the two dimensional bar code is a QR code.

20. Three dimensional bar codes, comprising:
a plurality of two dimensional bar codes each encoded with data, wherein the sequence of bar codes is to be displayed, in a display device, in a sequence such that only one of the plurality of bar codes in the sequence is displayed at any one time.

21. The sequence of bar codes of claim 20, wherein the sequence of bar codes is displayed at a video frame rate.

22. The sequence of bar codes of claim 20, wherein the sequence of bar codes is displayed several times in succession, at least one of said bar codes indicating its position in the sequence of bar codes.

23. The sequence of bar codes of claim 20, wherein the two dimensional bar codes are QR codes.

24. A device, comprising:
a reader configured to read a dynamically displayed sequence of bar codes, wherein the sequence of bar codes includes a plurality of bar codes each encoded with data, wherein at least two of the bar codes of the plurality of bar codes are shown in succession, and wherein the sequence of bar codes conveys a set of data; and
a processor configured to analyze the sequence of bar codes to identify each bar code in the plurality of bar codes, decode each identified bar code to obtain the encoded data, and compile the encoded data to obtain the coherent set of data.

25. The device of claim 24, wherein the sequence of bar codes is displayed at a video frame rate.

26. The device of claim 24, wherein the sequence of bar codes is displayed several times in succession, at least one of said bar codes indicating its position in the sequence of bar codes.

27. The device of claim 24, wherein each bar code of the plurality of bar codes is a two dimensional bar code.

28. The device of claim 27, wherein the two dimensional bar code is a QR code.

29. A method of transferring data, comprising:
receiving a set of data;
dividing the set of data into a plurality of data subsets;
encoding each data subset of the plurality of data subsets into a bar code of a plurality of bar codes;
encoding each bar code of the plurality of bar codes with a frame identifier;
compiling the plurality of bar codes into a sequence of bar codes;
displaying, in a display device, the compiled sequence of bar codes in a sequence such that only one of the plurality of bar codes is displayed at any one time; and
repeating the displaying step for a predetermined period of time.

30. The method of claim 29, wherein the compiled sequence of bar codes is displayed at a video frame rate.

31. The method of claim 29, wherein each bar code of the plurality of bar codes is a two dimensional bar code.

32. The method of claim 31, wherein the two dimensional bar code is a QR code.
